(19) United States
(12) Patent Application Publication
(10) Pub. No.: US 2007/0287124 A1
(43) Pub. Date: Dec. 13, 2007

(54) System to assist in explaining condition of periodontal disease

(76) Inventors: Hidehiko Yamamoto, Tokyo (JP); Takeo Ikeda, Tokyo (JP); Shoji Taguchi, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/441,957

(22) Filed: May 26, 2006

(51) Int. Cl. A61C 11/00

(52) U.S. Cl. 433/55

(57) ABSTRACT

An image of intraoral bacteria captured under a phase-contrast microscope and an intraoral image taken with a digital camera are recorded and played back to show the patient those images. The present invention shows improvements in this procedure, such as that (1) the phase-contrast microscope is equipped with a camera of a digital output type, (2) the image of intraoral bacteria and the intraoral image are associated with each other, and (3) at least the intraoral image can be edited.

### BACKGROUND OF THE INVENTION

1. Field of the Invention

The present invention relates to an apparatus and method used when a dentist informs a patient of the condition of periodontal disease.

2. Description of the Related Art

Dentists observe patients' mouth cavities directly to diagnose periodontal diseases. In addition to the diagnoses, it is difficult for the dentists to have the patients understand the conditions of periodontal diseases properly. The patients cannot observe their mouth cavities without the aid of a mirror, and even when using the mirror, they find it difficult to observe their mouth cavities closely in detail. However, in order to continue with dental treatment, it is important that the dentists have the patients understand the symptoms of periodontal diseases correctly.

An apparatus that can be used for this purpose is disclosed in Japanese Patent Laid-Open No. 09-70410. Using this apparatus, images of patients' mouth cavities are captured into a computer prior to the start of dental treatment. The dentists can use the images of the patients' mouth cavities to show the patients computer simulations of dental treatment while referring to the past cases recorded on the computer.

However, this system cannot show bacteria that cause the periodontal diseases.

On the other hand, a system including apparatuses called PerioSaver™ and PerioMicro™ is commercially available. PerioMicro™ is a phase-contrast microscope equipped with a CCD camera. PerioSaver™ is a filing system, consisting of a computer and a monitor, which can process and store images captured with the CCD camera.

In operation, a dentist puts a tooth plaque sample taken from a patient's mouth on a slide glass, and places the slide glass on the stage of the phase-contrast microscope. An image of dental bacteria being observed is captured with the CCD camera as a moving image. Because the captured image is a moving image, the motion of bacteria can be actually observed, and this can give the patient a strong impression about the condition of periodontal disease. The moving image is captured and stored into the system.

In this system, a still image(s) of the patient's mouth cavity captured with a normal digital camera, patient's basic information (name, sex, date of birth, etc.), diagnostic findings, etc. are also entered into the computer. The moving image (from the phase-contrast microscope), the still image (of the patient's mouth cavity taken with the normal digital camera), the patient's basic information, and the diagnostic findings are collectively managed in the filing system so that they can be displayed at a time in different areas of the monitor screen. Therefore, the dentist can explain the patient about the condition of periodontal disease while showing the patient the monitor screen.

The CCD camera is, however, an analog CCD camera outputting analog signals. Therefore, the filing system needs to incorporate a video capture board. Various kinds of video capture boards are commercially available, and the products are updated frequently. It takes many man-hours to check the CCD camera and the video capture board for proper operation, and this increases the cost of the system product. Further, the analog CCD camera requires a dedicated power supply, and this limits the installation location of the system.

Further, in the system, the moving image from the phase-contrast microscope is not stored in association with the still image of the patient's mouth cavity. For this reason, it is difficult to explain the moving state of bacteria observed in the moving image in association with the symptoms in the patient's mouth cavity. Therefore, it is not easy to have the patient understand phenomena, for example, that (1) the gums are inflamed (red and swollen) when there are many bacteria in the patient's mouth cavity, and that (2) the inflammation becomes healed as the number of bacteria is reduced.

Further, the image-screen comparison function is weak in the system, that is, only two streams of moving images (from the phase-contrast microscope) can be displayed on a screen in parallel. In addition, the moving image and the still image cannot be displayed at a time in parallel. For these reasons, it is difficult to have the patient understand changes in periodontal symptoms in chronological order.

Further, there is no function for editing the images in the filing system. Therefore, when explaining the patient about the important part of the symptoms, the dentist has to point to a corresponding area of each image.

The system is not network-compatible as well, so that the system can only be used as a standalone system.

It is therefore an object of the present invention to improve at least one of the above problems with the system.

### BRIEF SUMMARY OF THE INVENTION

The system to assist in explaining the symptoms of periodontal disease (hereinafter called the “informing assistance system”) includes a phase-contrast microscope, a solid-state imaging camera for capturing an image observed under the phase-contrast microscope, and a computer into which the output of the camera is input. A program running on the computer has at least (1) a function for accepting and recording an intraoral image of the patient taken with a digital camera (a camera other than the solid-state imaging camera), (2) a function for accepting and recording an image of bacteria obtained from the patient's mouth cavity and observed under the phase-contrast microscope, and (3) a function for playing back the recorded intraoral image and the recorded image of intraoral bacteria.

According to a first aspect of the present invention, the informing assistance system is configured such that the solid-state imaging camera is of a digital output type. For example, such a digital output type of camera outputs digital images via a USB cable. This improvement eliminates the need for the informing assistance system of the present invention to incorporate a video capture board. Therefore, it is unnecessary to check the operation of the video capture board. In addition, there is also no need to provide a dedicated power supply for the camera, reducing the factors that limit the installation location of the system.

According to a second aspect of the present invention, the informing assistance system is configured to record the intraoral image and the image of intraoral bacteria in association with each other. This makes it easy for a dentist to explain the relation between the moving state of bacteria and the intraoral symptoms. For example, the patient can more easily understand phenomena, such as that (1) the gums are inflamed (red and swollen) when there are many bacteria in the patient's mouth cavity, and that (2) the inflammation becomes healed as the number of bacteria is reduced.

According to a third aspect of the present invention, the informing assistance system is configured to be able to edit the images. This allows the dentist to edit the images in a manner to make it easy for the patient to understand his or her symptoms.

The present invention can also be understood as a recording medium recording a program that runs on the computer.

The method of explaining periodontal disease implemented according to the present invention includes: accepting the shot intraoral image and the shot image of intraoral bacteria into the computer; recording the images in association with each other; and playing back the recorded intraoral image and the recorded image of intraoral bacteria to show the patient those images.

This method allows the dentist to explain the patient about his or her symptoms in a manner easy for the patient to understand using the two images of the patient's mouth cavity and the intraoral bacteria.

The method of explaining periodontal disease according to the present invention can also be understood as a method of obtaining informed consent concerning dental treatment from the patient.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a schematic view showing the structure of a system to assist in explaining the condition of periodontal disease (informing assistance system) according to a preferred embodiment of the present invention;

FIG. 2 is a block diagram showing the structure of an informing assistance system 1;

FIG. 3 is a flowchart for explaining dentist's work;

FIG. 4 is a view of a screen on which images of a patient's mouth cavity and intraoral bacteria are played back and edited;

FIG. 5 is a view of an area for instructing the contents of editing;

FIG. 6 is a view of a screen on which three different images are displayed in parallel; and

FIG. 7 is a view of a screen on which four different images are displayed in parallel.

### DETAILED DESCRIPTION OF THE PREFERRED EMBODIMENTS

A preferred embodiment of the invention is described below with reference to the accompanying drawings.

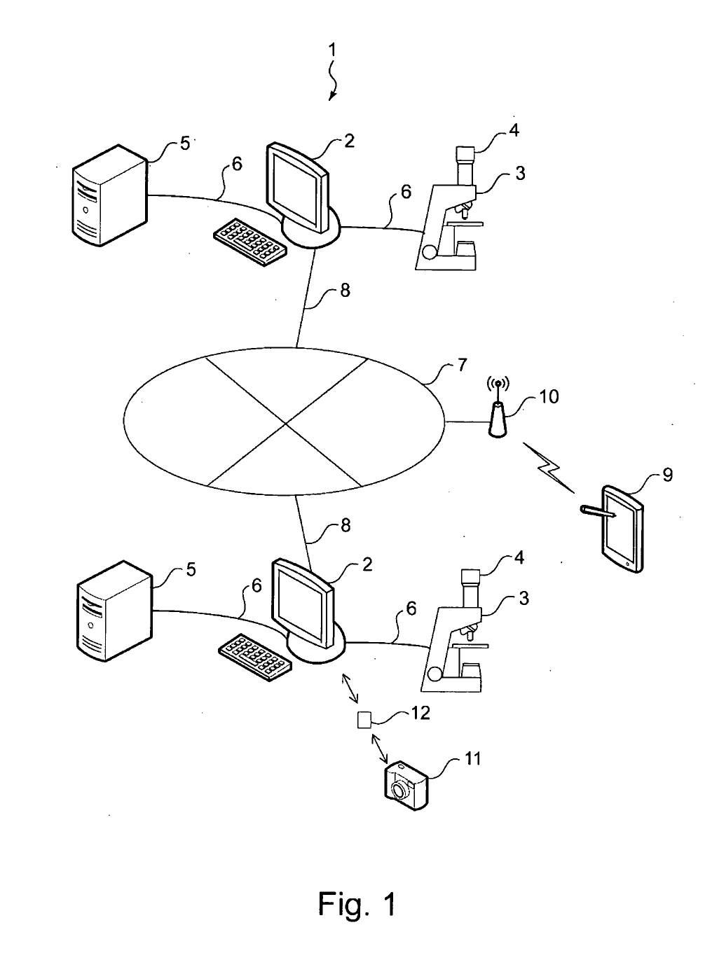

FIG. 1 is a schematic view showing the structure of a system to assist in explaining the condition of periodontal disease (informing assistance system) according to a preferred embodiment of the present invention.

An informing assistance system 1 is configured such that a microscope 3 and an external memory 5 are connected to a computer 2 through a signal cable 6. In the embodiment, the computer 2 is a personal computer (PC), and the microscope 3 is a phase-contrast microscope. A solid-state imaging camera (a CCD camera in the embodiment) 4 for imaging an object to be observed is attached to the microscope 3. The solid-state imaging camera 4 outputs digital signals, and the signals are input into the computer 2 via the signal cable 6 (a USB cable in the embodiment).

The external memory 5 is, for example, an external HDD for backup. The external memory 5 is not an essential structural element; it can be replaced by any other memory, such as a memory device incorporated in the computer 2 or a memory device on a network 7 to be described later.

The informing assistance system 1 is connected to the network 7 (an intra-network in the embodiment) through a line 8.

A wireless device 10 is provided on the network 7. Using the wireless device 10, a tablet PC 9 can be used as a terminal of the informing assistance system 1.

The informing assistance system 1 can accept images taken with a digital camera 11 via a recording medium 12 (a memory card in the embodiment). In an actual situation, a dentist or a dental assistant takes a picture(s) of a patient's mouth cavity with the digital camera 11 to obtain an intraoral image(s). The person who took the picture removes the recording medium 12 from the digital camera 11, and inserts it into the computer 2 to input the shot intraoral image into the informing assistance system 1.

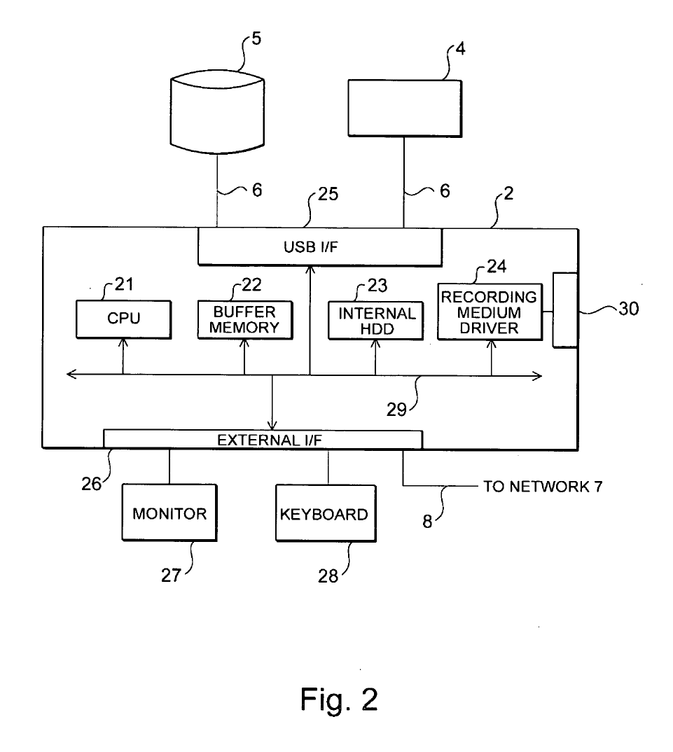

FIG. 2 is a block diagram showing the structure of the informing assistance system 1.

Inside the computer 2, a CPU 21, a buffer memory 22, an internal HDD 23, a recording medium driver 24, a USB-I/F 25, and an external I/F 26 are connected to an internal bus 29. A slot 30 for loading the recording medium 12 is connected to the recording medium driver 24.

The solid-state imaging camera 4 and the external memory 5 are connected to the USB-I/F 25 through the signal cable 6. A monitor 27, a keyboard 28, and the line 8 for accessing the network 7 are connected to the external I/F 26. A mouse, not shown, as a pointing device is connected to the keyboard 28.

The internal HDD 23 as a recording medium stores a program related to the informing assistance system 1 and executed by the CPU 21. Upon execution of the program, the program is read into the CPU 21 from the internal HDD 23 via the internal bus 29, expanded in an internal memory, not shown, of the CPU 21, and executed by the CPU 21.

The internal HDD 23 also stores not only an operating system for controlling the entire operation of the computer 2, but also image data (moving images and still images) used in the informing assistance system 1. If the internal HDD 23 does not have enough space, some of the image data are stored in the external memory 5. The external memory 5 is also used as a backup recording medium.

The buffer memory 22 is used for temporary storage of data to adjust the difference in transfer rate between the internal HDD 23 and the CPU 21.

The recording medium driver 24 is a circuit for controlling the reading of data from the recording medium 12 loaded in the slot 30.

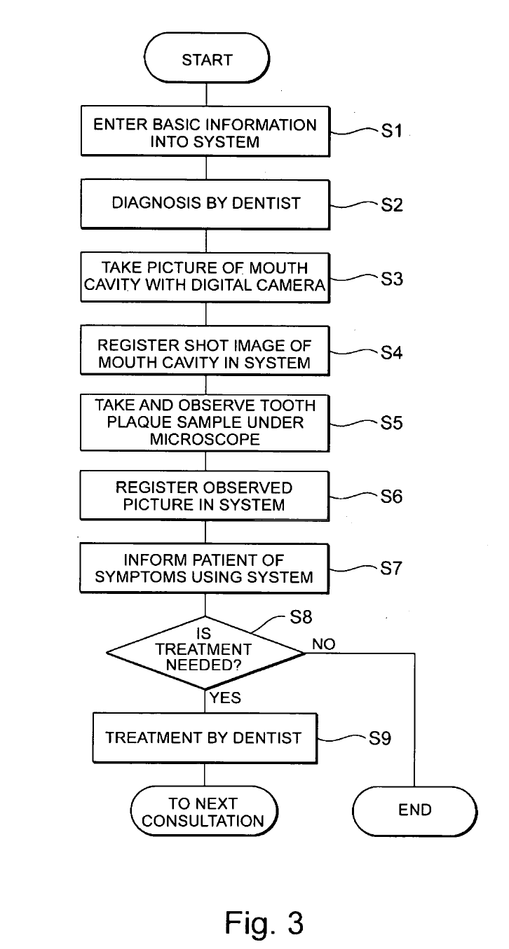

FIG. 3 is a flowchart for explaining dentist's work. Part of actual work can be done by a dental assistant under the direction of the dentist.

The dentist enters basic information on a patient via the keyboard 28 of the computer 2 (step S1). At the time of initial visit, the dentist enters the patient ID, name, date of birth, registration date, etc. as the patient's basic information. At the time of follow-up visit, the dentist enters only the patient ID.

The dentist diagnoses periodontal disease (step S2). The diagnosis is made by observing patient's mouth cavity directly. The informing assistance device 1 is not involved in the diagnosis. This diagnostic step 2 can be performed prior to step S1.

Next, the dentist takes a picture of the patient's mouth cavity with the digital camera 11 (step S3). The image of the mouth cavity (intraoral image) is used to see the condition of the patient's gums and know the condition of periodontal disease. For this purpose, the dentist captures the image for the best viewing of the patient's gums.

The intraoral image is captured as a still image. The intraoral image captured with the digital camera 11 is recorded on the recording medium 12 loaded in the digital camera 11.

Then, the dentist removes the recording medium 12 from the digital camera 11 and inserts it into the slot 30 of the computer 2. When the dentist instructs the computer using the keyboard 28 to accept the intraoral image recorded on the recording medium 12, the intraoral image is recorded on the internal HDD 23 and registered on the computer 2 (step S4).

Next, the dentist takes a tooth plaque sample from the patient and puts it on a slide glass. Then, the dentist places the slide glass on the stage of the microscope 3 to observe it under the microscope 3. The magnification is suitably in the range of 20 to 40 times. In this case, the motion of bacteria that has caused the periodontal disease can be observed under the microscope 3. The dentist captures a moving image of bacteria with the solid-state imaging camera 4 attached to the microscope 3 (step S5). In general, a moving image has a duration of 5 seconds to 5 minutes. The moving image of intraoral bacteria taken with the solid-state imaging camera 4 is output as digital signals from the solid-state imaging camera 4, and input into the computer 2 from the USB I/F 25 through the signal cable (USB cable) 6.

Then, when the dentist instructs the accepting of the moving image of the intraoral bacteria via the keyboard of the computer 2, the moving image is recorded on the internal HDD 23 (step S6). In the file system related to data management on the internal HDD 23, the intraoral image (still image) previously accepted and the image of the intraoral bacteria (moving image) accepted this time are recorded in association with each other. This association allows the image of the intraoral bacteria to be searched for from the intraoral image, or the intraoral image to be searched for from the image of the intraoral bacteria.

As an example of association methods, the moving image and the still image to be associated with each other are placed below the same folder, or a link is provided from the still image to the moving image.

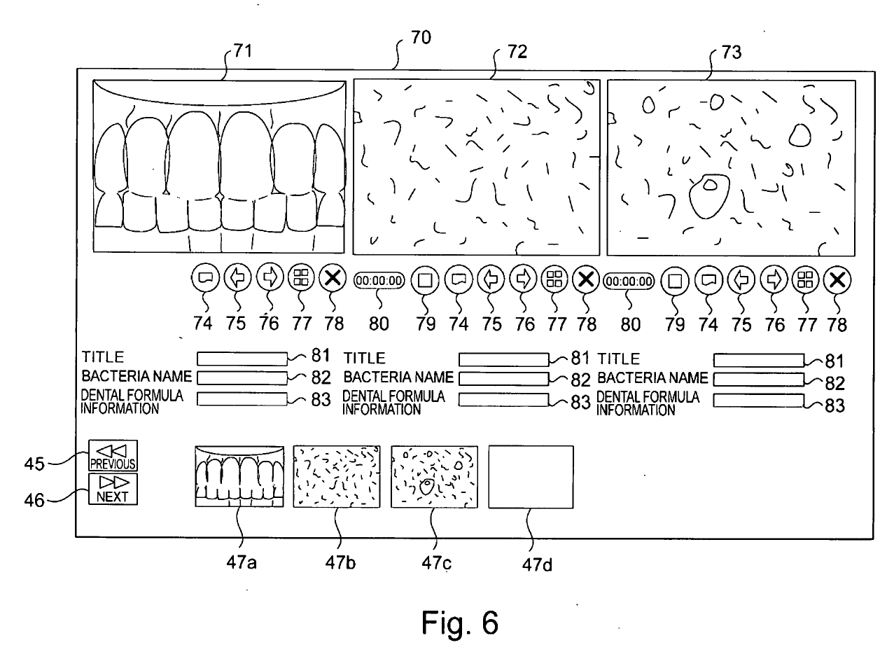

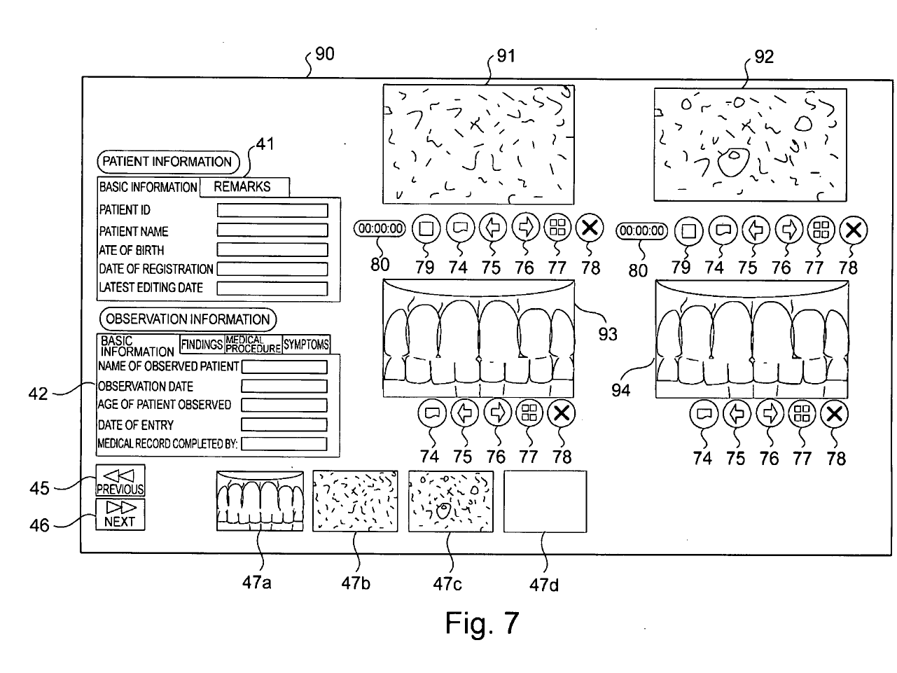

Next, the dentist uses the informing assistance system 1 to show the patient the intraoral image and the image of the intraoral bacteria associated with the intraoral image, explaining the patient about the condition of periodontal disease (step S7). The images used for explanation can be displayed on the monitor 27 of the computer 2, but if they are displayed on the tablet PC 9, it is convenient for the dentist to be able to talk to beside the patient sitting in a dental chair. FIGS. 6 and 7 show examples of images used for this purpose. If some treatment of periodontal disease is needed, the dentist will have to obtain informed consent from the patient.

Based on the diagnosis in step S2, the dentist determines whether some treatment is needed (step S8). If no treatment is needed, the procedure ends in this step, while if some treatment is needed, the dentist prepares for treatment.

The dentist gives a dental treatment to the patient if needed (step S9). The effect of the dental treatment will be explained to the patient at the next consultation using the informing assistance system 1.

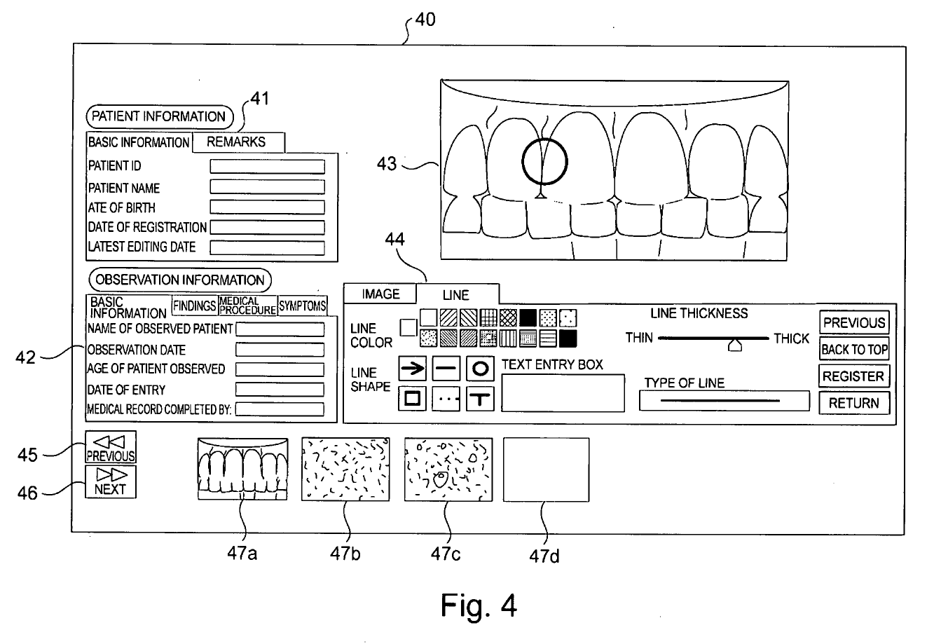

FIGS. 4 to 7 show image-associated functions implemented by the program related to the informing assist device 1.

FIG. 4 is a view of a screen 40 on which the dentist can play back and edit the intraoral image and the image of intraoral bacteria. The intraoral image registered in step S4 on the computer 2 and the image of the intraoral bacteria registered in step S6 on the computer 2 can be played back and edited on the screen 40. First, when the dentist enters the patient ID to call the screen 40, patient basic information 41, observation information 42, and an intraoral image 43 appear on the screen 40. In this case, thumbnails 47b-47d of images of intraoral bacteria that are associated with a thumbnail 47a of the intraoral image 47a also appear in the lower part of the screen 40. Note here that the thumbnails 47b-47d of the images of dental bacteria are the top frames of the moving images, that is, only the top frames of the moving images are displayed as still images. Further, in the example of FIG. 4, since the images of the intraoral bacteria associated with the thumbnail 47a of the intraoral image 47a are only two, a thumbnail frame 47d is blank.

Using buttons 45 and 46 on the screen 40, the dentist can move back and forth between the previous and next intraoral images. When the dentist calls the screen 40 for the first time, the latest intraoral image appears on the screen 40.

Although the intraoral image 43 appears when the dentist calls the screen 40 for the first time, the dentist can click on any of the thumbnails 47b-47d to replace the image 43 with the image corresponding to the clicked thumbnail. The top frames 47b-47d of the moving images of the intraoral bacteria are displayed as still images, but once any one of them is displayed in the image area 43, the corresponding image is played back as a moving image.

The intraoral image 43 can be edited. An area 44 is an editing instruction area. In FIG. 4, the area 44 indicates “line” editing so that the dentist can select a line marking for the intraoral image 43. In FIG. 4, a circle is marked in the intraoral image 43. The color, shape, thickness, and kind of a line (solid line, dotted line, broken line, etc.) can also be designated in the area 44. In addition, text can be entered in the area 44.

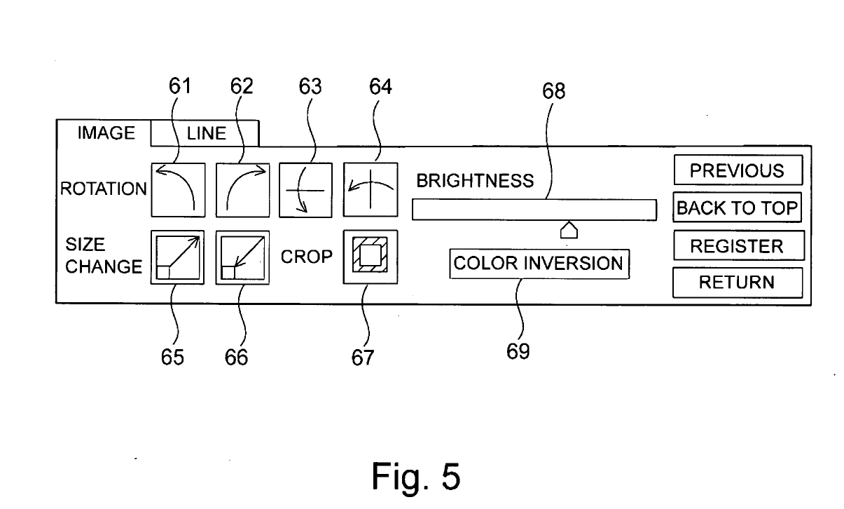

FIG. 5 is a view showing the area 44 when “image” is selected in the area 44. When “image” is selected in the area 44, the following image editing tools for editing the intraoral image 43 can be used: namely rotation, size change, crop, brightness change, and color inversion.

In order to rotate the marking, the following four buttons are provided; namely a button 61 for 180-degree counterclockwise rotation, a button 62 for 180-dgree clockwise rotation, a button 63 for upside-down mirroring, and a button 64 for left-to-right mirroring. In order to change the image size, a scale-up button 65 and a scale-down button 66 are provided. A crop button 67 is also provided.

Further, a slider 68 to change the brightness of the marking and a button 69 to invert the color of the marking are provided.

Thus, on the screen 40 shown in FIG. 4, a marking and text can be added to the intraoral image or the image of intraoral bacteria. Further, the attributes of the marking can be changed in various ways. Therefore, the dentist can designate an important part of each image, or a portion on which the dentist wants to put emphasis, using the various marking and text. The dentist can also edit the intraoral image and the image of the intraoral bacteria in a manner easy for the patient to look at.

FIG. 6 is a view of a screen 70 on which three images are displayed in parallel. In the example of the screen 70, an intraoral image and images of intraoral bacteria associated with the intraoral image are displayed on the single screen 70. Since the intraoral image can be compared with the images of intraoral bacteria, the patient can easily understand his or her condition of periodontal disease.

An intraoral image 71 and images 72, 73 of intraoral bacteria are displayed on the screen 70. Icons displayed below the image windows are a print button 74 to instruct an external printer to print a report, a button 75 to switch to the previous image, a button 76 to switch to the next image, a scale-up button 77, a button 78 to close the screen, a stop button 79 (only for moving images), a playback time counter 80 (only for moving images).

Areas provided below these buttons are an area 81 to display the title of each image, an area 82 to display the name of bacteria related to the periodontal disease, and an area 83 to display dental formula information. Further, the buttons 45, 46 and the thumbnails 47a-47d, similar to those in FIG. 4, are displayed below these areas.

FIG. 7 is a view of a screen 90 on which four images 91 to 94 are displayed in parallel (in a matrix form in this example).

Thus, in the embodiment, the moving images of intraoral bacteria are captured with the solid-state imaging camera of a digital output type. Therefore, no video capture board is needed in the system. If the moving images are output via USB, no dedicated power supply will be needed as well.

Further, the intraoral image and the image of intraoral bacteria are recorded on the computer 2 in association with each other. This makes it easy to display the intraoral image and the image of dental bacteria associated with the intraoral image at a time on a screen, making easy an effective presentation.

Furthermore, since the intraoral image and the image of intraoral bacteria can be edited, the dentist can explain the patient about the condition of periodontal disease using the edited images in a manner easy for the patient to understand.

While there has been shown and described what is considered to be a preferred embodiment of the invention, it will, of course, be understood that various modifications and changes in form or detail could readily be made without departing from the spirit of the invention. It is therefore intended that the invention not be limited to the exact form described and illustrated, but constructed to cover all modifications that may fall within the scope of the appended claims.

What is claimed is:

1. An informing assistance system to assist in explaining the condition of periodontal disease, comprising:
a phase-contrast microscope;
a solid-state imaging camera of a digital output type for capturing an image observed under the phase-contrast microscope;
a computer into which the digital output of the camera is input; and
a recording medium recording a program that runs on the computer,
wherein the program has at least
(1) a function for accepting and recording an intraoral image of the patient taken with another digital camera,
(2) a function for accepting and recording an image of bacteria obtained from the patient's mouth cavity and observed under the phase-contrast microscope, and
(3) a function for playing back the recorded intraoral image and the recorded image of intraoral bacteria.

2. The system according to claim 1, wherein the intraoral image is a still image, and the image of intraoral bacteria is a moving image.

3. An informing assistance system to assist in explaining the condition of periodontal disease, comprising:
a phase-contrast microscope;
a solid-state imaging camera for capturing an image observed under the phase-contrast microscope;
a computer into which the output of the camera is input; and
a recording medium recording a program that runs on the computer,
wherein the program has at least
(1) a function for accepting an intraoral image of the patient taken with a digital camera and the image of bacteria obtained from the patient's mouth cavity and observed under the phase-contrast microscope, and recording the images in association with each other, and
(2) a function for playing back, on the same screen, the intraoral image and the image of intraoral bacteria associated with each other.

4. The system according to claim 3, wherein three or more images can be played back in parallel on the same screen using the function for playing back the images.

5. An informing assistance system to assist in explaining the condition of periodontal disease, comprising:
a phase-contrast microscope;
a solid-state imaging camera for capturing an image observed under the phase-contrast microscope;
a computer into which the output of the camera is input; and
a recording medium recording a program that runs on the computer,
wherein the program has at least
(1) a function for accepting and recording an intraoral image of the patient taken with a digital camera,
(2) a function for accepting and recording an image of bacteria obtained from the patient's mouth cavity and observed under the phase-contrast microscope,
(3) a function for editing at least the recorded intraoral image, and
(4) a function for playing back the edited intraoral image and the image of intraoral bacteria.

6. The system according to claim 5, wherein the editing function has at least one of the following features: image rotation, image inversion, change in image brightness, image crop, image scale-up, and image scale-down.

7. A recording medium recording a program that runs on a computer in an informing assistance system to assist in explaining the condition of periodontal disease, the system including phase-contrast microscope, a solid-state imaging camera for capturing an image observed under the phase-contrast microscope, and a computer into which the output of the camera is input,
wherein the program has at least
(1) a function for accepting and recording an intraoral image of the patient taken with a digital camera,
(2) a function for accepting and recording, as digital data, an image of bacteria obtained from the patient's mouth cavity and observed under the phase-contrast microscope, and
(3) a function for playing back the recorded intraoral image and the recorded image of intraoral bacteria.

8. A recording medium recording a program that runs on a computer in an informing assistance system to assist in explaining the condition of periodontal disease, the system including phase-contrast microscope, a solid-state imaging camera for capturing an image observed under the phase-contrast microscope, and a computer into which the output of the camera is input,
wherein the program has at least
(1) a function for accepting an intraoral image of the patient taken with a digital camera and the image of bacteria obtained from the patient's mouth cavity and observed under the phase-contrast microscope, and recording the images in association with each other, and
(2) a function for playing back, on the same screen, the intraoral image and the image of intraoral bacteria associated with each other.

9. The recording medium according to claim 8, wherein three or more images can be played back in parallel on the same screen using the function for playing back the images.

10. A recording medium recording a program that runs on a computer in an informing assistance system to assist in explaining the condition of periodontal disease, the system including phase-contrast microscope, a solid-state imaging camera for capturing an image observed under the phase-contrast microscope, and a computer into which the output of the camera is input,
wherein the program has at least
(1) a function for accepting and recording an intraoral image of the patient taken with a digital camera,
(2) a function for accepting and recording an image of bacteria obtained from the patient's mouth cavity and observed under the phase-contrast microscope,
(3) a function for editing at least the recorded intraoral image, and
(4) a function for playing back the edited intraoral image and the image of intraoral bacteria.

11. The recording medium according to claim 10, wherein the editing function has at least one of the following features: image rotation, image inversion, change in image brightness, image crop, image scale-up, and image scale-down.

12. A method of explaining periodontal disease comprising:
taking a picture of a patient's mouth cavity with a digital camera;
accepting and recording the shot intraoral image into a computer;
observing bacteria obtained from the patient's mouth cavity under a phase-contrast microscope and taking a moving picture of intraoral bacteria observed;
accepting the shot image of intraoral bacteria into the computer and recording it in association with the intraoral image; and
playing back the recorded intraoral image and the recorded image of the intraoral bacteria to show the patient those images.

13. A method of explaining periodontal disease comprising:
allowing a dentist to show a patient an intraoral image of the patient and an image of intraoral bacteria associated with the intraoral image;
allowing the dentist to explain the patient about the condition of periodontal disease while referring to the images; and
allowing the dentist to obtain informed consent concerning dental treatment from the patient.

14. A method of allowing a dentist to explain a patient about the condition of periodontal disease and obtain informed consent concerning dental treatment from the patient, the method comprising:
diagnosing the patient as periodontal disease;
taking a picture of the patient's mouth cavity to obtain an intraoral image;
storing the shot intraoral image into the computer;
taking a tooth plaque sample from the patient;
placing the tooth plaque sample on a phase-contrast microscope and capturing an image of intraoral bacteria with a camera attached to the phase-contrast microscope;
storing the captured image of intraoral bacteria into the computer in association with the intraoral image;
playing back the intraoral image and the image of the intraoral bacteria to show the patient those images; and
obtaining informed consent concerning dental treatment from the patient.
